(19) United States
(12) Patent Application Publication
(10) Pub. No.: US 2026/0036830 A1
(43) Pub. Date: Feb. 5, 2026

(54) Rimless Glasses

(71) Applicant: Mei-Yueh Hou, Tainan (TW)

(72) Inventor: Mei-Yueh Hou, Tainan (TW)

(73) Assignee: TEAMWORKS GLASSES CORP., Tainan (TW)

(21) Appl. No.: 18/791,479

(22) Filed: Aug. 1, 2024

(51) Int. Cl. G02C 1/02; G02C 5/02

(52) U.S. Cl. CPC G02C 1/02; G02C 5/02

(57) ABSTRACT

A pair of a rimless glasses includes two lenses having two first perforations and two second perforations on two side edges respectively, and a first fixing element and a second fixing element on the inner side surfaces, a nose bridge having a metal bridge body with two first tooth nails engaged into the two sleeves of the first fixing element, covered by a plastic bridge sleeve, two end pieces having a metal inner body with two second tooth nails engaged into the two sleeves of the second fixing element, covered by a plastic end piece sleeve and two temples. Two sleeves of the first fixing element and the second fixing element are respectively inserted into the two first perforations and the second perforations of the lenses. The two lenses is connected by the nose bridge. The two temples are respectively assembled on the pivot lugs of the two end pieces.

### BACKGROUND OF THE PRESENT INVENTION

### Field of Invention

The present invention relates to rimless glasses with a plastic assembly containing embedded metal.

### Description of Related Arts

According to the conventional rimless glasses 1 as shown in FIG. 1, is mainly composed of two lenses 10, a nose bridge 11, two end pieces 12 and two temples 13. Each of the lenses 10 has two perforations 100, 101 arranged respectively on two sides. The nose bridge 11 is arranged between the two lenses 10. The nose bridge 11 has two through holes 110 respectively arranged on two opposite terminals of the nose bridge 11 thereof. Each of two first screws is inserted into the each of two through holes 110, extending through the perforation 100 that aligns with the through holes 110 on the inner side of the two lenses 10. Then, each of two first nuts 112 is screwed onto each of the first screw 111 to secure the nose bridge 11 firmly between the two lenses 10. The nose bridge 11 is equipped with two nose pads 113 arranged oppositely underneath. Each of the two end pieces 12 is positioned oppositely on the outer sides of the two lenses 10. Each of the end piece 12 is designed a thru-hole 120 at one end and a pivot seat 121 at the other end. Each of two second screws 122 is inserted through the thru-hole 120 of the end pieces 12 and into the perforation 101 on the opposite outer sides of the two lenses 10. Subsequently, each of two second nut 123 is screwed onto the second screw 122 to secure the end pieces 12 on the outer side of the two lenses 10. In addition, each of the temples 13 is pivotally connected to the pivot seat 121 of each of the end pieces 12 through a pivot member 124, completing the assembly of the conventional rimless glasses 1. However, in such conventional rimless glasses 1, the nose bridge 11 and the end pieces 12 are secured on the lenses 10 by screws and nuts. Overtime, the screws and nuts are often loosened at the assembly part, causing the discomfort for the wearer, so “re-tightening them with tools” becomes necessary, adding to the inconvenience during assembly and use. Moreover, in the conventional rimless glasses, the nose bridge, the end pieces, and the temples are made of metal to enhance structural strength. However, using metal increases the weight of rimless glasses, causing discomfort during wear. Conversely, opting for plastic can lighten the weight of the glasses, but this material is prone to deformation and lacks strength, making the glasses fragile and susceptible to breakage.

### SUMMARY OF THE PRESENT INVENTION

A main object of the present invention is to provide a pair of rimless glasses with a plastic assembly containing embedded metal, which can effectively improve the shortcomings of the heavy weight and poor strength of a pair of rimless glasses.

A pair of rimless glasses of the present invention consists of two lenses, a nose bridge, two end pieces, and two temples. Each of the two lenses features two first perforations and two second perforations located respectively on two literal side thereof, wherein each of the two lenses includes a first fixing element and a second fixing element both made of plastic material, which are respectively arranged on the inner side surfaces of the lenses, wherein the first fixing element and the second fixing element respectively has two sleeves protruding thereon, wherein the two sleeves of the first fixing element are inserted into the two first perforations of the lenses, wherein the two sleeves of the second fixing element are inserted into the second perforations of the lenses, wherein right between the two lenses are connected by a nose bridge includes a metal bridge body covered by a plastic bridge sleeve, wherein the bridge body has two first tooth nails respectively arranged at two ends of the inner side surface thereof, wherein the two first tooth nails are engaged in the two sleeves of the first fixing element, wherein the bridge body has two nose pad holders extending backward and downward, and arranged on the inner side surface thereof, and two nose pads assembled on the two nose pad holders respectively, wherein on the inner surface of the bridge sleeve is set a groove able to insert the bridge body, wherein the two end pieces are respectively arranged on the opposite outer edges of the two lenses, wherein each of the two end pieces consists of a metal inner body and a plastic end piece sleeve covered on the inner body, wherein the inner body has two second tooth nails respectively arranged at one end of the inner side surface thereof, and has a pivot lug arranged at the other end thereof, wherein the two second tooth nails are engaged in the two sleeves of the second fixing element, wherein on the inner surface of the end piece sleeve is set a slot able to be inserted by the inner body, wherein the two temples are respectively pivotally assembled on the pivot lugs of the two end pieces.

The rimless glasses structure of the present invention has the advantages of using a plastic embedded metal structure, which makes the glasses light in weight, good in strength, not easy to deform, and not easy to break. In addition, the color of the plastic parts on the appearance can be diverse, which can increase the diversity of the overall changes of the glasses.

### BRIEF DESCRIPTION OF THE DRAWINGS

FIG. 1 is an exploded view of the conventional rimless glasses.

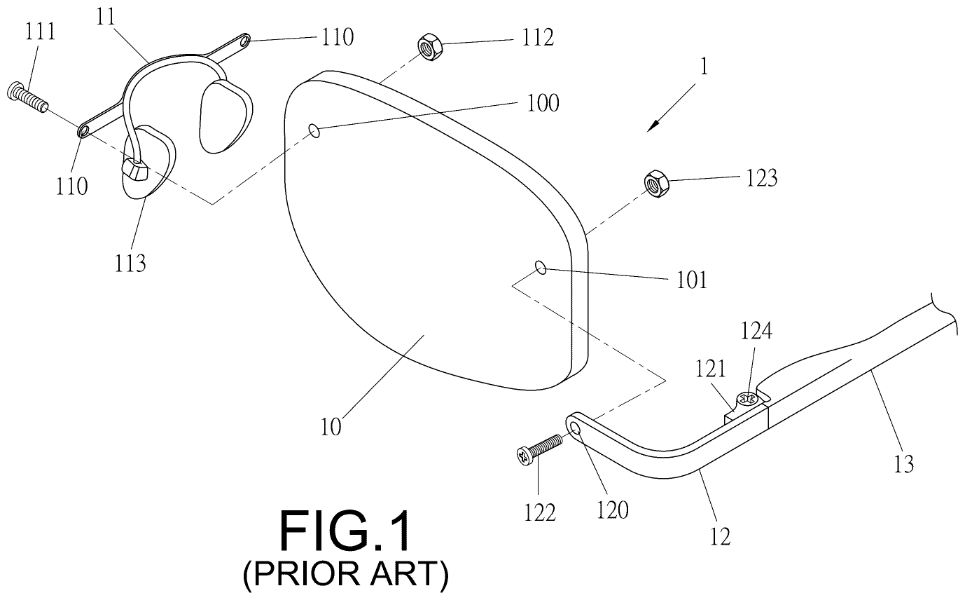

FIG. 2 is an exploded view according to an embodiment of the present invention.

FIG. 3 is a perspective view according to the embodiment of the present invention.

FIG. 4 is a perspective view according to the embodiment of the present invention from another angle.

FIG. 5 is a sectional view of A-A in FIG. 3 according to the embodiment of the present invention.

FIG. 6 is a top view according to the embodiment of the present invention.

### DETAILED DESCRIPTION OF THE PREFERRED EMBODIMENT

Regarding the technical means adopted by the present invention to achieve the above-mentioned purposes and effects, the best and feasible embodiments are enumerated and shown in the drawings, and are described in detail as follows:

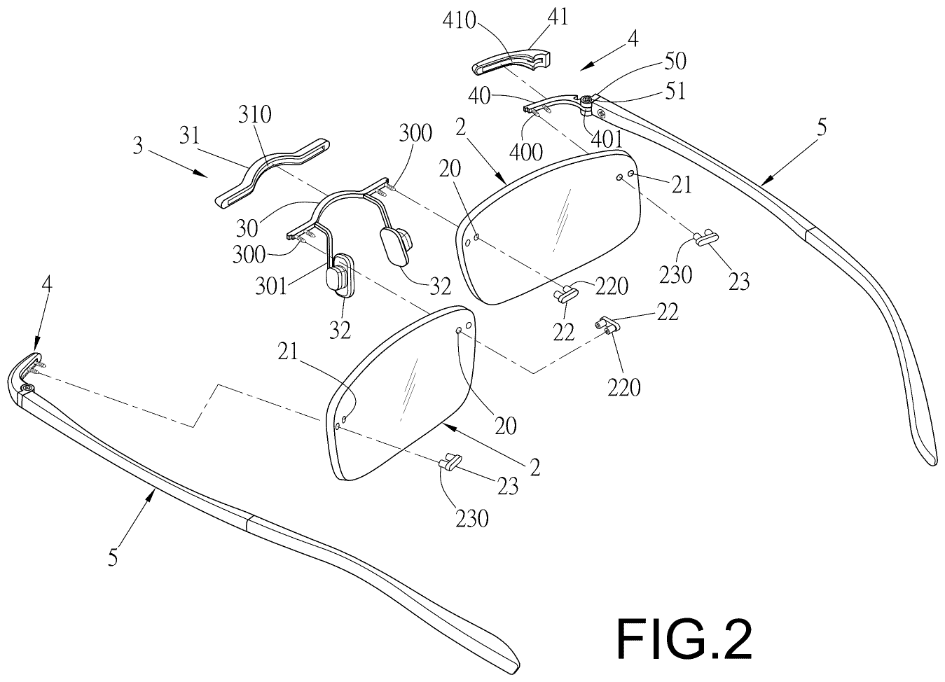

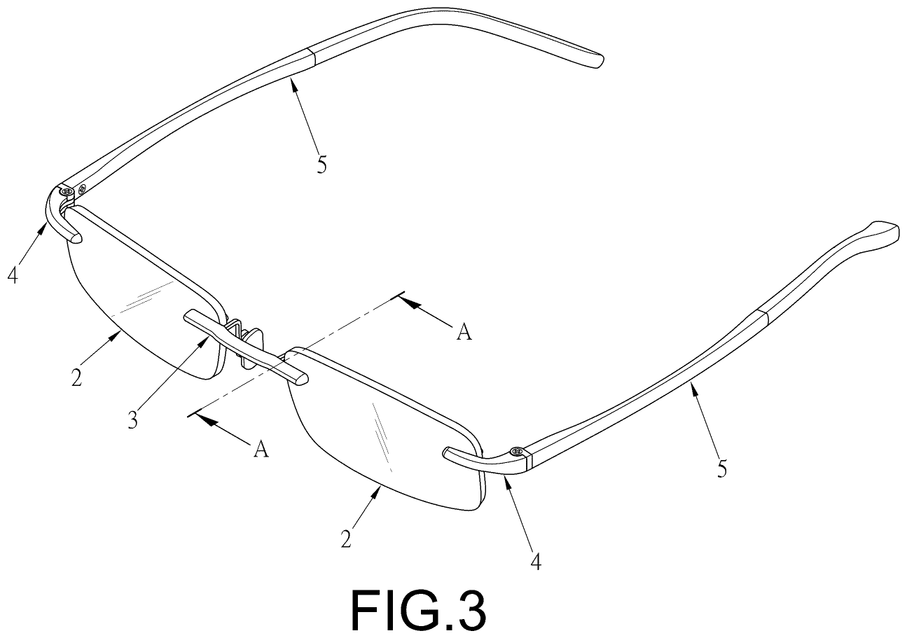

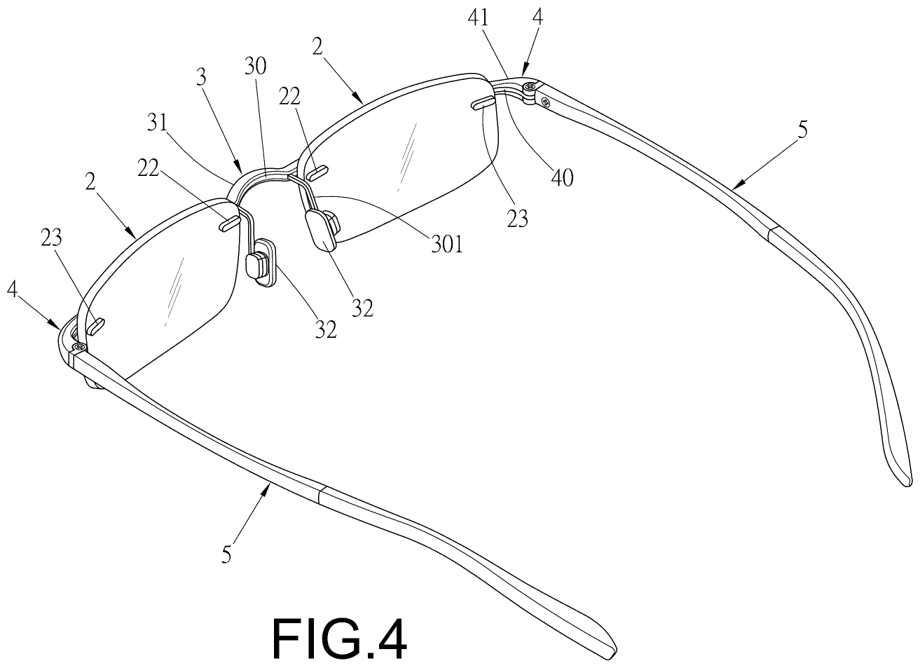

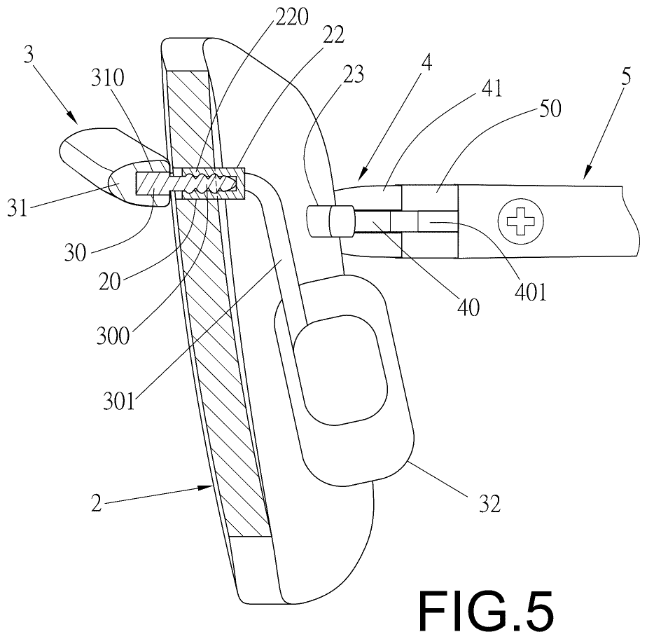

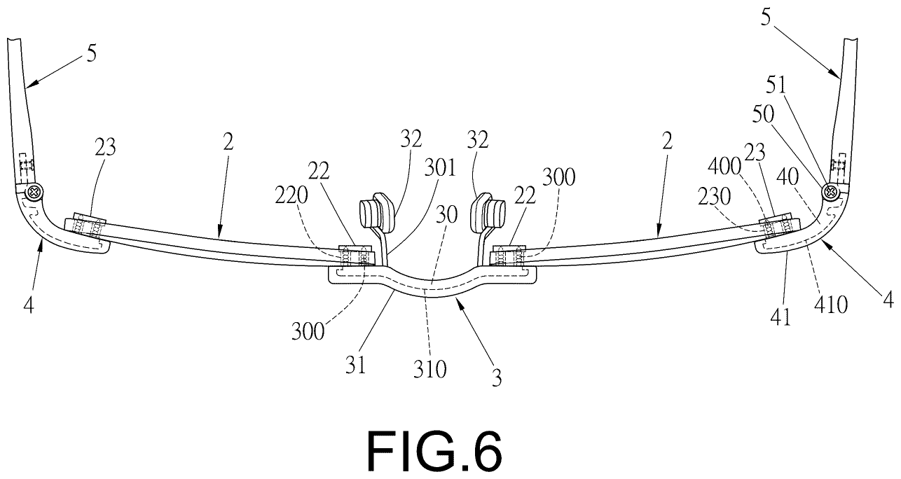

According to the embodiment of the present invention, as shown in FIGS. 2 to 6, the pair of the rimless glasses consists two lenses 2, a nose bridge 3, two end pieces 4 and two temples 5, wherein each of the two lenses 2 includes two first perforations 20 and two second perforations 21 located respectively on two side edges thereof, wherein each of the two lenses 2 includes a first fixing element 22 and a second fixing element 23, which are respectively arranged on the inner side surfaces of the first perforations 20 and the second perforations 21, wherein the first fixing element 22 and the second fixing element 23 are both made of plastic material, wherein the first fixing element 22 and the second fixing element 23 both have two sleeves 220 and 230 protruding thereon, wherein the sleeves 220 of the first fixing element 22 are inserted into the first perforations 20 of the lenses 2, wherein the sleeves 230 of the second fixing element 23 are inserted into the second perforations 21 of the lenses 2, wherein the nose bridge 3 is arranged right between the two lenses 2, wherein the nose bridge 3 includes a bridge body made of metal and covered by a bridge sleeve 31 made of plastic, wherein the bridge body 30 has two first tooth nails 300 respectively arranged at two ends of the inner side surface thereof, wherein the bridge body 30 has two nose pad holders 301 extending backward and downward, and arranged on the inner side surface thereof, and two nose pads 32 assembled on the two nose pad holders 301 respectively, wherein the bridge body 31 has a groove 310 provided on the inner side surface thereof for the bridge body 30 to be inserted into, wherein the two end pieces 4 are respectively arranged on the opposite outer side edges of the two lenses 2, wherein each of the two end pieces 4 includes an inner body 40 made of metal and covered by an end piece sleeve 41 made of plastic, wherein the inner body 40 has two second tooth nails 400 respectively arranged at one end of the inner side surface thereof, and has a pivot lug 401 arranged at the other end thereof, wherein the end piece outer body 41 has a slot 410 on the inner side surface able to insert the inner body 40, wherein the two temples 5 are respectively assembled on the two end pieces 4, wherein each of the temples 5 has a pivot seat 50 disposed at the front end thereof, and the pivot seat 50 of each of the temples 5 is pivoted to the pivot lug 401 of each of the end pieces 4 through a pivot component 51, so that, which is a pair of rimless glasses.

When assembling the present invention, referring to FIGS. 2 to 6. First, setting the two sleeves 220 of each plastic first fixing element 22 into the two first perforations 20 of each of the lenses 2 respectively, and setting the two sleeves 230 of each second fixing element 23 into the two second perforations 21 of each of the lenses 2 respectively, and fixing the first fixing element 22 and the second fixing element 23 on the inner surface of the lenses 2. Then, putting the bridge body 30 made of metal into the groove 310 of the bridge sleeve 31 made of plastic, so that the bridge body 30 and the bridge sleeve 31 are combined into one body, that is, the assembly of the nose bridge 3 is completed. And then, inserting the first tooth nails 300 on two ends of the assembled nose bridge 3 into the first perforations 20 corresponding to the two lenses 2, pressing the first tooth nails 300 into the sleeves 220 of the first fixing element 22, and fixing the nose bridge 3 between the two lenses 2 by the teeth of the first tooth nails 300 engaging with the inner wall of the sleeves 220. Next, arranging the inner body 40 made of metal in the groove 410 of the end piece sleeve 41 made of plastic, so that the end piece inner body 40 and the end piece sleeve 41 are combined as a whole, thereby completing the assembly of the end pieces 4. And next, inserting the second tooth nails 400 at one end of the assembled end pieces 4 into the second perforations 21 on the outside of the two lenses 2, pressing the second tooth nails 400 into the sleeves 230 of the second fixing elements 23, and fixing the end pieces 4 to the outer side edge of the two lenses 2 by the teeth of the second tooth nails 400 engaging with the inner wall of the sleeves 230. Finally, assembling and pivoting the pivot lug 401 of end pieces 4 and the pivot seat 50 of temples 5, and pivoting by the pivot components 51, to complete the overall assembly of rimless glasses. The present invention is made to make the nose bridge 3 and the end pieces 4 assembled on the lenses 2 more stable because the inner and outer side edges of the lenses 2 are respectively provided with two first perforations 20 and two second perforations 21, so that the assembly parts will not be loosened, displaced, or deformed.

The connecting parts of the nose bridge 3 and the end pieces 4 of the rimless glasses of the present invention are combined by using a structure in which plastic is filled with metal. By utilizing advantage of the lightness and thinness of the plastic exterior and the strength of the built-in metal, the appearance of plastic parts can be thin and not easy to deform or break, which can solve the conventional shortcomings of simple plastic components being easily deformed and simple metal components being heavy. In addition, the appearance of the plastic parts of the present invention can be diversified in color, which can increase the diversity of the overall changes of the glasses.

In summary, the present invention has achieved the expected objects and effects, and is more ideal and practical than prior art. However, the above-mentioned embodiments are only for specifically describing the preferred embodiments of the present invention, and the embodiments are not intended to limit the scope of the present application. Also, other equivalent changes and modifications made without departing from the technical means disclosed in the present invention are intended to be included in the patent scope of the present invention.

What is claimed is:

1. A pair of rimless glasses comprises two lenses, a nose bridge, two end pieces, and two temples, arranged thereon respectively, wherein each of the two lenses comprises two first perforations and two second perforations respectively arranged on two side edges thereof, wherein each of the two lenses comprises a first fixing element and a second fixing element both made of plastic material, which are respectively arranged on the inner side surfaces thereof, wherein the first fixing element and the second fixing element each of which has two sleeves protruding thereon, wherein the two sleeves of the first fixing element are inserted into the two first perforations of the lenses, wherein the two sleeves of the second fixing element are inserted into the second perforations of the lenses, wherein the nose bridge is arranged between the two lenses, wherein the nose bridge comprises a metal bridge body covered by a plastic bride sleeve, wherein the bridge body has two first tooth nails respectively arranged at two ends of the inner side surface thereof, wherein the two first tooth nails are engaged into the two sleeves of the first fixing element, wherein the bridge body has two nose pad holders extending backward and downward, and arranged on the inner side surface thereof, and two nose pads assembled on the two nose pad holders respectively, wherein on the inner side surface of the bridge body is set a groove able to insert the bridge body, wherein the two end pieces are respectively arranged on the opposite outer edges of the two lenses, wherein each of the two end pieces comprises a metal inner body and a plastic end piece sleeve cover on the inner body, wherein the inner body has two second tooth nails respectively arranged at one end of the inner side surface thereof, and has a pivot lug arranged at the other end thereof, wherein the two second tooth nails are engaged into the two sleeves of the second fixing element, wherein on the inner surface of the end piece sleeve is set a slot able to be inserted by the inner body, wherein the two temples are respectively pivotally assembled on the pivot lugs of the two end pieces.
